(19) United States
(12) Patent Application Publication
(10) Pub. No.: US 2016/0274284 A1
(43) Pub. Date: Sep. 22, 2016

(54) OPTICAL CONVERSION MEMBER, POLARIZING PLATE, LIQUID CRYSTAL PANEL, BACKLIGHT UNIT, AND LIQUID CRYSTAL DISPLAY DEVICE

(71) Applicant: FUJIFILM Corporation, Tokyo (JP)

(72) Inventor: Hiroyuki ISHIKAWA, Kanagawa (JP)

(73) Assignee: FUJIFILM Corporation, Tokyo (JP)

(21) Appl. No.: 15/171,332

(22) Filed: Jun. 2, 2016

Related U.S. Application Data
(63) Continuation of application No. PCT/JP2014/082202, filed on Dec. 5, 2014.

(30) Foreign Application Priority Data
Dec. 6, 2013 (JP) 2013-252738

(51) Int. Cl. G02B 5/30; G02F 1/13363; G02F 1/1335

(52) U.S. Cl. CPC G02B 5/3016; G02F 1/133528; G02F 1/13363; G02B 5/3083; G02F 2001/133541; G02F 2001/133543; G02F 2001/133638; G02F 2413/01

(57) ABSTRACT

One embodiment of the present invention relates to an optical conversion member including an optical conversion layer containing a quantum dot emitting fluorescent light which is excited by incident excitation light, and a polyvinyl acetal resin layer.

### CROSS-REFERENCE TO RELATED APPLICATIONS

This application is a Continuation of PCT International Application No. PCT/JP2014/082202 filed on Dec. 5, 2014, which claims priority under 35 U.S.C §119(a) to Japanese Patent Application No. 2013-252738 filed on Dec. 6, 2013. Each of the above applications is hereby expressly incorporated by reference, in its entirety.

### BACKGROUND OF THE INVENTION

1. Field of the Invention

The present invention relates to an optical conversion member, and specifically, relates to an optical conversion member which has excellent transparency and is able to exhibit high light emission efficiency for a long period of time.

Further, the present invention also relates to a polarizing plate, a liquid crystal panel, a backlight unit, and a liquid crystal display device including the optical conversion member.

2. Description of the Related Art

A flat panel display such as a liquid crystal display device (hereinafter, also referred to as LCD) has been widely used annually as a space saving image display device having low power consumption. The liquid crystal display device is configured of at least a backlight and a liquid crystal cell, and typically, includes members such as a backlight side polarizing plate and a visible side polarizing plate.

In the flat panel display market, improvement in color reproducibility has progressed as LCD performance has improved. In this point, recently, a quantum dot (also referred to as QD) has attracted attention as a light emission material (refer to US2012/0113672A1). For example, in a case where excitation light is incident on an optical conversion member containing a quantum dot from a backlight, the quantum dot is excited and emits fluorescent light. Here, by using the quantum dots having different light emission properties, white light is able to be embodied by emitting each bright line light of red light, green light, and blue light. The fluorescent light of the quantum dot has a small half-width, and thus, the obtained white light has a high brightness and an excellent color reproducibility. According to the progress of three-wavelength light source technology using such a quantum dot, a color reproduction range has widened to 100% from 72% of the current TV standard (Full High Definition (FHD)), National Television System Committee (NTSC)) ratio.

### SUMMARY OF THE INVENTION

In the quantum dot, light emission efficiency decreases due to a photooxidization reaction in a case where the quantum dot is in contact with oxygen. In this point, in US2012/0113672A1, it has been disclosed that the quantum dot is dispersed in an organic matrix having low light transmittance, such as oxygen, and thus, a quantum dot layer (a QD film) is prepared, and various polymers are exemplified as the organic matrix. However, in a case where the dispersion of the quantum dot into the organic matrix is insufficient, transparency of the quantum dot layer decreases (haze occurs), and as a result thereof, brightness and contrast of LCD decrease.

Therefore, an object of the present invention is to provide an optical conversion member containing a quantum dot, which has excellent transparency and is able to exhibit high light emission efficiency (have high weather fastness) for a long period of time.

The present inventors have conducted studies in order to attain the object described above, and have focused on the fact that among various polymers exemplified as the organic matrix in US2012/0113672A1, polyvinyl butyral is excellent for oxygen barrier properties. However, according to the studies of the present inventors, in the optical conversion member including an optical conversion layer in which the quantum dot is dispersed in polyvinyl butyral, transparency and weather fastness deteriorate. In this point, as a result of further studies of the present inventors, it has been considered that the reason for a decrease in the transparency is that it is difficult for the organic matrix to excellently disperse the quantum dot in polyvinyl alcohol, and the reason for a decrease in the weather fastness is that barrier performance of the organic matrix is insufficient. It is considered that the main reason for a decrease in the weather fastness is that it is not possible to sufficiently prevent the quantum dot from being in contact with oxygen in the vicinity of the surface of the optical conversion layer in the organic matrix.

As a result of more intensive studies of the present inventors based on the findings described above, it has been newly found that polyvinyl acetal such as polyvinyl butyral is laminated on an optical conversion layer not as an organic matrix of the optical conversion layer but as a barrier layer, and thus, it is possible to provide an optical conversion member which has excellent transparency and is able to exhibit high light emission efficiency for a long period of time, and thus, completed the present invention.

One embodiment of the present invention relates to an optical conversion member comprising: an optical conversion layer containing a quantum dot emitting fluorescent light which is excited by incident excitation light; and a polyvinyl acetal resin layer.

In an embodiment, the optical conversion layer includes the polyvinyl acetal resin layer respectively on both main surfaces. That is, in an embodiment, each main surface has the polyvinyl acetal resin layer thereon.

The main surface described above indicates a surface (a front surface and a back surface) arranged on a visible side or a backlight side at the time of being used, but the polyvinyl acetal resin layer may be disposed on at least one surface of four side surfaces. Preferably, the polyvinyl acetal resin layer is disposed on both surfaces and all side surfaces of the optical conversion layer. That is, in one preferred embodiment, a polyvinyl acetal resin is contained as a sealing material, and the optical conversion layer is sealed with the polyvinyl acetal resin layer.

In one embodiment, the polyvinyl acetal resin layer is disposed as an adjacent layer which is directly in contact with the optical conversion layer.

In one embodiment, in the polyvinyl acetal resin layer, the content of the plasticizer with respect to 100 parts by mass of the polyvinyl acetal is less than or equal to 10 parts by mass, and in another embodiment, is greater than or equal to 0 parts by mass and less than 4 parts by mass.

In one embodiment, an average degree of polymerization of the polyvinyl acetal contained in the polyvinyl acetal resin layer is greater than or equal to 100 and less than or equal to 4000.

In one embodiment, the optical conversion layer is a cured material layer of a curable composition containing a quantum dot.

In one embodiment, the curable composition contains a (meth)acrylate compound selected from the group consisting of a monofunctional (meth)acrylate monomer and a multifunctional (meth)acrylate monomer.

In one embodiment, the curable composition contains a boric acid-based compound selected from the group consisting of a boric acid-containing compound and a boric acid ester-containing compound.

In one embodiment, the quantum dot includes a semiconductor nanocrystal having a core-shell structure.

In one embodiment, the quantum dot is a cadmium-free material.

In one embodiment, the quantum dot is at least one selected from the group consisting of a quantum dot A having a light emission center wavelength in a wavelength range of 600 nm to 680 nm, a quantum dot B having a light emission center wavelength in a wavelength range of 500 nm to 600 nm, and a quantum dot C having a light emission center wavelength in a wavelength range of 400 nm to 500 nm.

Another embodiment of the present invention relates to a polarizing plate, comprising: the optical conversion member described above; and a polarizer which is a cholesteric liquid crystal layer allowing circularly polarized light to exit, in which a λ/4 plate is disposed between the optical conversion member and the cholesteric liquid crystal layer as an adjacent layer which is directly in contact with a polyvinyl acetal resin layer of the optical conversion member. In the polarizing plate described above, the polyvinyl acetal layer is able to function as an alignment film at the time of preparing the λ/4 plate. In one embodiment, the polarizer is a reflection polarizer.

Still another embodiment of the present invention relates to a liquid crystal panel, comprising at least: a liquid crystal cell; and the polarizing plate described above.

In one embodiment, the liquid crystal panel includes a visible side polarizing plate, the liquid crystal cell, and a backlight side polarizing plate, and the backlight side polarizing plate is a polarizing plate comprising the optical conversion member described above, and the optical conversion member is arranged between the λ/4 plate and the liquid crystal cell.

Still another embodiment of the present invention relates to a liquid crystal display device, comprising: the liquid crystal panel described above; and a backlight unit including a light source.

Still another embodiment of the present invention relates to a backlight unit, comprising: the optical conversion member described above; and a light source.

Still another embodiment of the present invention relates to a liquid crystal display device, comprising: a liquid crystal panel; and the backlight unit.

According to one embodiment of the present invention, it is possible to provide an optical conversion member which has high transparency and excellent weather fastness.

Further, according to one embodiment of the present invention, it is possible to provide a polarizing plate which includes the optical conversion member described above and a polarizer.

According to another embodiment of the present invention, it is possible to provide a liquid crystal panel, a backlight unit, and a liquid crystal display device which include the optical conversion member described above.

### BRIEF DESCRIPTION OF THE DRAWINGS

FIG. 1 illustrates a layer configuration of an optical conversion member (sealed with a polyvinyl butyral resin layer) prepared in Example 1.

### DESCRIPTION OF THE PREFERRED EMBODIMENTS

The following description is based on representative embodiments of the present invention, but the present invention is not limited to such embodiments. Furthermore, in the present invention and herein, a numerical range denoted by using “to” indicates a range including numerical values before and after “to” as the lower limit value and the upper limit value.

In addition, in the present invention and herein, a “half-width” of a peak indicates the width of a peak at a height of ½ of a peak height. In addition, light having a light emission center wavelength in a wavelength range of 400 nm to 500 nm, and preferably 430 nm to 480 nm will be referred to as blue light, light having a light emission center wavelength in a wavelength range of 500 nm to 600 nm will be referred to as green light, and light having a light emission center wavelength in a wavelength range of 600 nm to 680 nm will be referred to as red light.

In the present invention and herein, the unit of retardation is nm. Re(λ) and Rth(λ) each represent in-plane retardation and retardation in a thickness direction at a wavelength of λ. Re(λ) is measured by allowing light having a wavelength of λ nm to be incident in a film normal direction using KOBRA 21ADH or WR (manufactured by Oji Scientific Instruments). The measurement is able to be performed by manually replacing a wavelength selective filter or by converting a measured value with a program or the like in a case of selecting a measurement wavelength of λ nm. In a case where a film to be measured is denoted by a monoaxial index ellipsoid or a biaxial index ellipsoid, Rth(λ) is calculated by the following method.

In Rth(λ), Re(λ) described above is measured at a total of 6 points by allowing the light having a wavelength of λ nm to be incident from directions respectively inclined in a 10° step from a normal direction to 50° on one side with respect to the film normal direction in which an in-plane slow axis (determined by KOBRA 21ADH or WR) is used as an inclination axis (a rotational axis) (in a case where there is no slow axis, an arbitrary direction of a film plane is used as the rotational axis), and Rth(λ) is calculated by KOBRA 21ADH or WR on the basis of the measured retardation value, an assumed value of the average refractive index, and the input film thickness value. In the above description, in a case of a film having a direction in which a retardation value at a certain inclination angle is zero by using the in-plane slow axis as the rotational axis from the normal direction, a retardation value at an inclination angle greater than the inclination angle described above is changed to have a negative sign, and then, Rth(λ) is calculated by KOBRA 21ADH or WR. Furthermore, a retardation value is measured from two arbitrarily oblique directions by using the slow axis as the inclination axis (the rotational axis) (in a case where there is no slow axis, an arbitrary direction of the film plane is used as the rotational axis), and Rth is able to be calculated by Expression (A) described below and Expression (B) described below on the basis of the retardation value, an assumed value of the average refractive index, and the input film thickness value.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos ( {sin}^{- 1} ( \frac{sin ( - θ )}{nx} ) )} \qquad Expression ( A )$$

Furthermore, Re(θ) described above indicates a retardation value in a direction inclined by an angle of θ from the normal direction. In addition, in Expression (A), nx represents a refractive index in a slow axis direction in the plane, ny represents a refractive index in a direction orthogonal to nx in the plane, and nz represents a refractive index in a direction orthogonal to nx and ny. d represents a film thickness.

Rth=((nx+ny)/2−nz)×d Expression (B)

In a case where the film to be measured is a so-called film not having an optic axis which is not able to be denoted by a monoaxial index ellipsoid or a biaxial index ellipsoid, Rth(λ) is calculated by the following method. In Rth(λ), Re(λ) described above is measured at 11 points by allowing the light having a wavelength of λ nm to be incident from directions respectively inclined in a 10° step from −50° to +50° with respect to the film normal direction in which the in-plane slow axis (determined by KOBRA 21ADH or WR) is used as the inclination axis (the rotational axis), and Rth(λ) is calculated by KOBRA 21ADH or WR on the basis of the measured retardation value, an assumed value of the average refractive index, and the input film thickness value. In addition, in the measurement described above, a catalog value of various optical films in a polymer handbook (JOHN WILEY & SONS, INC) is able to be used as the assumed value of the average refractive index. In a case where the value of the average refractive index is not known in advance, the value of the average refractive index is able to be measured by using an ABBE'S REFRACTOMETER. The value of the average refractive index of a main optical film will be exemplified as follows: cellulose acylate (1.48), a cycloolefin polymer (1.52), polycarbonate (1.59), polymethyl methacrylate (1.49), and polystyrene (1.59). The assumed values of the average refractive index and the film thickness are input, and thus, nx, ny, and nz are calculated by KOBRA 21ADH or WR. Nz=(nx−nz)/(nx−ny) is further calculated by the calculated nx, ny, and nz.

Furthermore, herein, “visible light” indicates light in a range of 380 nm to 780 nm. In addition, herein, in a case where a measurement wavelength is not particularly described, the measurement wavelength is 550 nm

In addition, herein, an angle (for example, an angle of “90°” or the like), and a relationship thereof (for example “orthogonal”, “parallel”, “intersect”, and the like) include an error range which is allowable in the technical field belonging to the present invention. For example, the angle indicates a range of less than an exact angle of ±10°, and an error with respect to the exact angle is preferably in a range of less than or equal to 5°, and is more preferably in a range of less than or equal to 3°.

Herein, a “slow axis” indicates a direction in which a refractive index is maximized. In addition, herein, a “front surface” indicates a normal direction with respect to a display surface.

[Optical Conversion Member]

An optical conversion member according to one embodiment of the present invention includes an optical conversion layer containing a quantum dot emitting fluorescent light which is excited by incident excitation light, and a polyvinyl acetal resin layer. As described above, the polyvinyl acetal resin layer is disposed as a barrier layer, preferably as a sealing material, and thus, weather fastness is able to be improved without decreasing transparency of the optical conversion layer.

Hereinafter, the optical conversion member will be described in more detail. Furthermore, the optical conversion member and the optical conversion layer are able to also be referred to as a wavelength conversion member and a wavelength conversion layer.

Optical Conversion Layer

The optical conversion layer contains at least one type of quantum dot, and is also able to contain two or more types of quantum dots having different light emission properties. A known quantum dot includes a quantum dot A having a light emission center wavelength in a wavelength range of 600 nm to 680 nm, a quantum dot B having a light emission center wavelength in a wavelength range of 500 nm to 600 nm, and a quantum dot C having a light emission center wavelength in a wavelength range of 400 nm to 500 nm, and the quantum dot A emits red light which is excited by excitation light, the quantum dot B emits green light, and the quantum dot C emits blue light. For example, in a case where blue light is incident on an optical conversion layer containing the quantum dot A and the quantum dot B as excitation light, it is possible to embody the white light by the red light emitted from the quantum dot A, the green light emitted from the quantum dot B, and the blue light transmitted through the optical conversion layer. Alternatively, ultraviolet light is incident on an optical conversion layer containing the quantum dots A, B, and C as excitation light, and thus, it is possible to embody the white light by the red light emitted from the quantum dot A, the green light emitted from the quantum dot B, and the blue light emitted from the quantum dot C. In general, the quantum dots are semiconductor crystal (semiconductor nanocrystal) particles having a nano order size, particles in which the surface of a semiconductor nanocrystal is modified by an organic ligand, or particles in which the surface of a semiconductor nanocrystal is covered with a polymer layer. In general, the light emission wavelength of the quantum dot is able to be adjusted by the composition of the particles, the size of the particles, and the composition and the size.

Examples of the quantum dot include a II-VI compound such as CdSe, CdTe, CdS, ZnSe, ZnTe, ZnS, HgTe, or HgS.

In addition, preferred embodiments of the quantum dot are able to include a quantum dot having a core-shell structure. A particle which becomes a core is covered with a shell having a wider band gap, and thus, it is possible to considerably improve quantum efficiency, and it is possible to obtain a quantum dot having high light emission efficiency. Examples of the core are able to include any one selected from the group consisting of CdSe, CdTe, CdS, ZnSe, ZnTe, ZnS, HgTe, and HgS. Examples of the shell are able to include any one selected from the group consisting of CdSe, CdTe, CdS, ZnSe, ZnTe, ZnS, HgTe, and HgS. Further, a III-V compound such as InP may be used.

More preferred embodiments of the quantum dot having a core-shell structure are able to include a quantum dot having a so-called core-multi-shell structure in which a shell has a multi-layer structure. One or two or more shells having a narrow band gap are laminated on a core having a wide band gap, and a shell having a wide band gap is further laminated on the shell, and thus, it is possible to obtain a quantum dot having higher light emission efficiency.

Examples of the quantum dot are able to include a quantum dot in which the surface of semiconductor crystal particles is covered with an organic ligand and a quantum dot in which the surface of semiconductor crystal particles is covered with a protective layer. The surface of the semiconductor crystal particles is modified by the organic ligand or is covered with the protective layer, and thus, it is possible to improve the chemical stability of the quantum dot. Examples of the organic ligand are able to include pyridine, mercapto alcohol, thiol, phosphine, a phosphine oxide, and the like. On the other hand, epoxy, silicon, an acrylic resin, glass, a carbonate-based resin, a mixture thereof, and the like may be used in the protective layer.

The quantum dot as described above is able to be synthesized by a known method, and is available as a commercially available product. The details, for example, can be referred to the description disclosed in US2010/123155A1, JP2012-509604A, U.S. Pat. No. 8,425,803A, JP2013-136754A, WO2005/022120A, JP2006-521278A, and the like.

Here, a quantum dot containing cadmium has been known as the quantum dot, but recently, a cadmium-free quantum dot has been required from the viewpoint of reducing an environmental load. However, the cadmium-free quantum dot easily deteriorates due to oxygen or the like, compared to a cadmium-containing quantum dot. In contrast, in one embodiment of the present invention, the deterioration of the quantum dot contained in the optical conversion layer is able to be prevented by the polyvinyl acetal resin layer. Therefore, according to one embodiment of the present invention, it is possible to increase weather fastness of the optical conversion member containing the quantum dot which is a cadmium-free material.

The optical conversion layer of the optical conversion member is able to contain the quantum dot in an organic matrix. In general, the organic matrix is a polymer which is polymerized by performing light irradiation or the like with respect to a polymerizable composition. The shape of the optical conversion layer is not particularly limited, and the optical conversion layer is able to have an arbitrary shape such as a sheet-like shape and a bar-like shape.

It is preferable that the optical conversion layer is prepared by a coating method. Specifically, a polymerizable composition (a curable composition) containing a quantum dot is applied onto a substrate or the like, such as glass, and then, a curing treatment is performed by light irradiation or the like, and thus, an optical conversion layer is able to be obtained.

The polymerizable compound which is used for preparing the polymerizable composition is not particularly limited. A (meth)acrylate compound such as a monofunctional or multifunctional (meth)acrylate monomer, a polymer thereof, a prepolymer thereof, and the like are preferable from the viewpoint of transparency, adhesiveness, or the like of a cured film after being cured. Furthermore, in the present invention and herein, the “(meth)acrylate” is used as the concept including at least one of acrylate or methacrylate, or any one of acrylate and methacrylate. The same applies to “(meth)acryloyl” or the like.

Examples of the monofunctional (meth)acrylate monomer are able to include an acrylic acid and a methacrylic acid, and a derivative thereof, and more specifically, a monomer having one polymerizable unsaturated bond of a (meth)acrylic acid (one (meth)acryloyl group) in the molecules. Specific examples thereof can be referred to the description disclosed in paragraph [0022] of WO2012/077807A1.

A multifunctional (meth)acrylate monomer having two or more (meth)acryloyl groups in the molecules is able to be used along with a monomer having one polymerizable unsaturated bond of the (meth)acrylic acid (one (meth)acryloyl group) in one molecule. The details thereof can be referred to the description disclosed in paragraph [0024] of WO20121077807A1. In addition, a multifunctional (meth)acrylate compound disclosed in paragraphs [0023] to [0036] of JP2013-043382A is able to be used as the multifunctional (meth)acrylate compound. Further, an alkyl chain-containing (meth)acrylate monomer denoted by General Formulas (4) to (6) disclosed in paragraphs [0014] to [0017] of the specification of JP5129458B is also able to be used.

The use amount of the multifunctional (meth)acrylate monomer is preferably greater than or equal to 5 parts by mass, from the viewpoint of strength of a coating film, and is preferably less than or equal to 95 parts by mass from the viewpoint of suppressing gelation of the composition, with respect to 100 parts by mass of the total amount of the polymerizable compound contained in the polymerizable composition. In addition, from the same viewpoint, it is preferable that the use amount of the monofunctional (meth)acrylate monomer is greater than or equal to 5 parts by mass and less than or equal to 95 parts by mass, with respect to 100 parts by mass of the total amount of the polymerizable compound contained in the polymerizable composition. In addition, it is preferable that the content of the total polymerizable compound is approximately 10 mass % to 99.99 mass % with respect to the total amount of the polymerizable composition.

The polymerizable composition described above is able to contain a known radical initiator as a polymerization initiator. The polymerization initiator, for example, can be referred to the description disclosed in paragraph [0037] of JP2013-043382A. The amount of polymerization initiator is preferably greater than or equal to 0.1 mol %, and is more preferably 0.5 mol % to 5 mol %, with respect to the total amount of the polymerizable compound contained in the curable composition.

The quantum dot may be added in a state of the particles of the polymerizable composition, or may be added in a state of a dispersion in which the quantum dot is dispersed in a solvent. Adding the quantum dot in a state of the dispersion is preferable from the viewpoint of suppressing aggregation of the particles of the quantum dot. Here, a solvent to be used is not particularly limited. The added amount of the quantum dot, for example, is able to be approximately 0.01 parts by mass to 10 parts by mass, with respect to 100 parts by mass of the total amount of the composition.

In a preferred embodiment, the polymerizable composition described above contains one or more boric acid-based compounds selected from the group consisting of a boric acid-containing compound and a boric acid ester-containing compound. The boric acid-based compound contributes to the improvement in adhesiveness between the optical conversion layer and an adjacent layer, and in particular, in a case where the polyvinyl acetal resin layer is disposed as an adjacent layer which is directly in contact with the optical conversion layer, it is possible to considerably increase adhesiveness between the optical conversion layer and the polyvinyl acetal resin layer. Accordingly, a barrier effect of the polyvinyl acetal resin layer is more excellently exhibited, and thus, it is possible to further improve weather fastness. Here, direct contact indicates that two layers are arranged to be adjacent to each other without including other layers such as an adhesive layer therebetween.

Examples of a preferred boric acid-based compound are able to include a boric acid-based compound denoted by

T-X^{I}-Q. General Formula(Ia)

In General Formula (Ia), X¹ represents a divalent linking group, a hydrogen atom, or a substituted or non-substituted alkyl group, an alkenyl group, an alkynyl group, an aryl group, or a heteroaryl group, T represents a substituent group having a polymerizable group, and Q represents a boric acid or boric acid ester. Here, T may or may not be included, and in a case where T is included, X¹ represents a divalent linking group. The details of General Formula (Ia) can be referred to the description disclosed in paragraphs [0144] to [0167] of JP2012-150428A.

The polymerizable composition containing the quantum dot described above is applied onto a suitable support and is dried, and a solvent is removed, and then, the polymerizable composition is polymerized and cured by light irradiation or the like, and thus, a quantum dot layer is able to be obtained. Examples of a coating method include a known coating method such as a curtain coating method, a dip coating method, a spin coating method, a printing coating method, a spray coating method, a slot coating method, a roll coating method, a slide coating method, a blade coating method, a gravure coating method, and a wire bar method. In addition, curing conditions are able to be suitably set according to the type of polymerizable compound to be used or the composition of the polymerizable composition.

The total thickness of the optical conversion layer is preferably less than or equal to 500 μm from the viewpoint of obtaining sufficient excitation light transmittance, and is preferably greater than or equal to 1 μm from the viewpoint of obtaining sufficient fluorescent light. It is more preferable that the total thickness of the optical conversion layer is in a range of 100 μm to 400 μm. In addition, the optical conversion layer may have a laminated structure of two or more layers, or may a quantum dot layer containing two or more quantum dots having different light emission properties in the same layer. In a case where the optical conversion layer includes a plurality of quantum dot layers, the film thickness of one layer is preferably in a range of 1 μm to 300 μm, and is more preferably in a range of 10 μm to 250 μm.

Polyvinyl Acetal Resin Layer

In the optical conversion member according to one embodiment of the present invention, the optical conversion layer described above is protected by the polyvinyl acetal resin layer, and thus, it is possible to prevent a decrease in weather fastness due to the deterioration of the quantum dot.

The polyvinyl acetal resin layer is able to be disposed on the optical conversion layer through other layers such as an adhesive layer. Here, a known adhesive layer is able to be used as the adhesive layer or the like without any limitation. It is preferable that the polyvinyl acetal resin layer is disposed as an adjacent layer which is directly in contact with the optical conversion layer from the viewpoint of further improving the weather fastness.

The optical conversion layer is configured of two main surfaces of a front surface and a back surface, and four side surfaces, and the polyvinyl acetal resin layer is disposed on at least one surface. It is preferable that a wider area is protected by the polyvinyl acetal resin layer from the viewpoint of improving the weather fastness. From this viewpoint, the polyvinyl acetal resin layer is preferably disposed on any one main surface, is more preferably disposed on both main surfaces, and is even more preferably disposed on the entire surface of both main surfaces and four side surfaces, that is, the polyvinyl acetal resin layer is disposed as a sealing material.

The polyvinyl acetal resin layer contains at least polyvinyl acetal, and the content ratio of the polyvinyl acetal is preferably greater than or equal to 40 mass %, is more preferably greater than or equal to 50 mass %, is even more preferably greater than or equal to 60 mass %, and is still more preferably greater than or equal to 80 mass %, by setting the weight of the polyvinyl acetal resin layer as 100%. Resins other than the polyvinyl acetal are able to be mixed unless barrier properties of the polyvinyl acetal deteriorate, and an inorganic substance (titanium oxide, talc, or the like) is also able to be mixed. In particular, in a preferred embodiment, the total amount of the resin component is the polyvinyl acetal.

In the polyvinyl acetal, the content of a vinyl acetate component in the polyvinyl acetal is preferably less than or equal to 20 mol %, is more preferably less than or equal to 5 mol %, and is even more preferably less than or equal to 2 mol %.

In general, the polyvinyl acetal is configured of a vinyl acetal component, a vinyl alcohol component, and a vinyl acetate component, and the amount of each component, for example, is able to be measured on the basis of JIS K 6728: 1977 “Polyvinyl Butyral Test Method” or a nuclear magnetic resonance method (NMR).

In a case where the polyvinyl acetal contains components other than the vinyl acetal component, in general, the amount of vinyl alcohol component and the amount of vinyl acetate component are measured, and the amount of both components is subtracted from the total amount of polyvinyl acetal, and thus, the amount of remaining vinyl acetal component is able to be calculated.

Polyvinyl acetal which is obtained by allowing aldehydes to react with polyvinyl alcohol is able to be used as the polyvinyl acetal. Such polyvinyl acetal is able to be manufactured by a known method.

The average degree of polymerization of the polyvinyl acetal is preferably in a range of 100 to 5000, is more preferably in a range of 400 to 3000, is even more preferably in a range of 600 to 2500, is still more preferably in a range of 700 to 2300, and is still even more preferably in a range of 750 to 2000, from the viewpoint of enabling excellent film formation to be performed. The average degree of polymerization of the polyvinyl acetal is coincident with the average degree of polymerization of the polyvinyl alcohol which is a raw material. The average degree of polymerization of the polyvinyl alcohol, for example, is able to be measured on the basis of JIS K 6726 “Polyvinyl Alcohol Test Method”.

In addition, the acid value of the polyvinyl acetal is preferably less than or equal to 0.50 KOHmg/g, is more preferably less than or equal to 0.30 KOHmg/g, is even more preferably less than or equal to 0.10 KOHmg/g, and is still more preferably less than or equal to 0.06 KOHmg/g, from the viewpoint of suppressing coloration and preventing corrosion of the polyvinyl acetal resin layer. In addition, the acid value of the polyvinyl acetal, for example, is greater than or equal to 0.01 KOHmg/g, but is not particularly limited. Here, the acid value of the polyvinyl acetal is a value measured on the basis of JIS K6728: 1977.

The details of a preparation method or the like of polyvinyl alcohol, aldehyde, and polyvinyl acetal which are used as a raw material of the polyvinyl acetal can be referred to as the description disclosed in paragraphs [0028] to [0039], [0052], [0053] to [0060] of the specification of JP5231686B. Various aldehydes disclosed in paragraph [0035] of the specification of JP5231686B are able to be exemplified as the aldehyde. Aldehyde having approximately 2 to 6 carbon atoms is desirable as the aldehyde, and in consideration of further improving the weather fastness, butyl aldehyde is preferable. That is, the polyvinyl acetal which is preferably used in one embodiment of the present invention is polyvinyl butyral.

A suitable amount of plasticizer is able to be added to the polyvinyl acetal resin layer from the viewpoint of improving film forming properties or the like, and in a case where the plasticizer is added, it is preferable that the content of the plasticizer is less than or equal to 10 parts by mass with respect to 100 parts by mass of the polyvinyl acetal. This is because moisture permeability of the polyvinyl acetal resin layer increases due to the plasticizer, and thus the barrier effect of the polyvinyl acetal resin layer decreases. The added amount of the plasticizer is more preferably less than or equal to 8 parts by mass, is even more preferably less than or equal to 5 parts by mass, is still more preferably less than 4 parts by mass, is still even more preferably less than or equal to 3 parts by mass, and is further even more preferably less than or equal to 2 parts by mass, and may be 0 parts by mass, with respect to 100 parts by mass of the polyvinyl acetal. The details of the plasticizer which is able to be used can be referred to the description disclosed in paragraphs [0042] to [0043] of the specification of JP5231686B. In addition, the polyvinyl acetal resin layer is able to contain a known additive. The details of the plasticizer which is able to be used can be referred to the description disclosed in paragraphs [0044] to [0049] of the specification of JP5231686B.

The polyvinyl acetal described above is independently and homogeneously kneaded, or as necessary, is homogeneously kneaded by formulating a suitable amount of additive, and then, a sheet is prepared by a known film formation method such as extruding method, a calendering method, a pressing method, a casting method, and an inflation method, and the sheet is bonded to the optical conversion layer, and thus, the polyvinyl acetal resin layer is able to be disposed on the optical conversion layer. The details of a preparation method of the sheet can be referred to the description disclosed in paragraph [0051] of the specification of JP5231686B. The bonding, for example, is performed by an adhesive layer, by lamination using an adhesive agent, or by lamination without using an adhesive agent (thermal pressure bonding). The lamination of the thermal pressure bonding is preferable since the polyvinyl acetal resin layer is able to be disposed as the adjacent layer which is directly in contact with the optical conversion member from the viewpoint of further improving the weather fastness.

The thickness of the polyvinyl acetal resin layer is not particularly limited, the lamination is easily performed as the thickness increases, and cost advantages are obtained as the thickness decreases. From the viewpoint described above, the thickness of the polyvinyl acetal resin layer is preferably in a range of 10 μm to 10,000 μm, is more preferably in a range of 50 μm to 3,000 μm, and is even more preferably in a range of 100 μm to 1,000 μm.

The optical conversion member described above is able to be used as a configuration member of a liquid crystal display device. In one embodiment, a configuration member of a liquid crystal panel of a liquid crystal display device is able to be used as a configuration member of a backlight unit in another embodiment. The details of the embodiments will be described below.

[Polarizing Plate and Liquid Crystal Panel]

Another embodiment of the present invention relates to a polarizing plate including the optical conversion member described above, and a polarizer which is a cholesteric liquid crystal layer allowing circularly polarized light to exit, in which a λ/4 plate is arranged between the optical conversion member and the cholesteric liquid crystal layer as an adjacent layer which is directly in contact with the polyvinyl acetal resin layer of the optical conversion member.

In general, in order to prepare the λ/4 plate, an alignment film for aligning a liquid crystal compound contained in the λ/4 plate is used. In contrast, in the polarizing plate described above, the polyvinyl acetal resin layer for protecting the optical conversion layer is able to have a function as the alignment film for preparing the λ/4 plate. Thus, the number of configuration members is reduced by setting one layer to have two functions, and thus, it is possible to realize a reduction in thickness and weight of the liquid crystal display device.

Still another embodiment of the present invention relates to a liquid crystal panel including at least a liquid crystal cell, and the polarizing plate described above.

The polarizing plate described above is able to allow the circularly polarized light exiting from the polarizer to be converted into linearly polarized light by the λ/4 plate and to be incident on the liquid crystal cell, and thus, in a preferred embodiment, is used as a backlight side polarizing plate of the liquid crystal panel. In this case, the optical conversion member is arranged between the λ/4 plate and the liquid crystal cell. In the liquid crystal panel described above, the optical conversion member is arranged to face the liquid crystal cell, and the optical conversion member is arranged between the λ/4 plate and the liquid crystal cell. Therefore, the circularly polarized light exiting from the polarizer is able to be incident on the liquid crystal cell by being changed to the linear polarized light by the λ/4 plate, by being incident on the optical conversion member, and by being subjected to optical conversion (wavelength conversion) in the optical conversion member. In another embodiment, the polarizing plate of the optical conversion member described above includes a reflection polarizer, and is arranged on the surface of the backlight side polarizing plate on the backlight side as a so-called brightness enhancement layer.

Hereinafter, the polarizing plate and the liquid crystal panel described above will be described in more detail.

(Polarizing Plate)

The cholesteric liquid crystal layer of the polarizing plate described above may have at least a polarization function, and preferably has a function as the reflection polarizer. The reflection polarizer has a function of reflecting light in a first polarization state and of transmitting light in a second polarization state in incidence light. The light in the first polarization state which is reflected on the reflection polarizer is recirculated by randomizing the direction and the polarization state using a reflection member of the backlight unit (also referred to as a light guide device or an optical resonator), and the brightness of the image display device is able to be improved. Accordingly, brightness of a display surface of the liquid crystal display device is able to be improved. That is, in an embodiment including the reflection polarizer as the polarizer, the polarizing plate described above is able to function as a brightness enhancement layer. The light in the second polarization state which is transmitted through the reflection polarizer (for example, left circularly polarized light) is able to be converted into the linearly polarized light by the λ/4 plate, and is able to be incident on the liquid crystal cell. The light in the second polarization state is able to be transmitted through the polarizer (a linear polarizer). The λ/4 plate may be a single layer, or a laminated body of two or more layers, and the laminated body of two or more layers is preferable.

It is preferable that the cholesteric liquid crystal layer which is used as the reflection polarizer allowing the circularly polarized light to exit is a reflection polarizer including a first light reflection layer which has a reflection center wavelength in a wavelength range of 430 nm to 480 nm, has a reflectivity peak having a half-width of less than or equal to 100 nm, allows circularly polarized light to exit, and is formed by immobilizing a cholesteric liquid crystalline phase, a second light reflection layer which has a reflection center wavelength in a wavelength range of 500 nm to 600 nm, has a reflectivity peak having a half-width of less than or equal to 100 nm, allows circularly polarized light to exit, and is formed by immobilizing a cholesteric liquid crystalline phase, and a third light reflection layer which has a reflection center wavelength in a wavelength range of 600 nm to 650 nm, has a reflectivity peak having a half-width of less than or equal to 100 nm, allows circularly polarized light to exit, and is formed by immobilizing a cholesteric liquid crystalline phase.

Here, a brightness enhancement layer of the related art provides a broadband optical recycling function with respect to white light, and thus, manufacturing costs increase on complicated design in consideration of a multi-layer configuration and wavelength dispersibility of a member. In contrast, the liquid crystal panel according to one embodiment of the present invention includes the optical conversion member containing the quantum dot, and thus, it is possible to obtain bright line light of RGB (preferably having a half-width of less than or equal to 100 nm) of which the light emission peak of an RGB wavelength range is narrow. Therefore, a light utilization rate increases by using the reflection polarizer having a narrow reflection peak in the RGB wavelength range, and thus, it is possible to improve front brightness, front surface contrast, and a color reproduction range by a simple configuration. It is preferable that the reflection polarizer described above includes only the first light reflection layer, the second light reflection layer, and the third light reflection layer as the cholesteric liquid crystal layer from the viewpoint of decreasing the film thickness of the polarizing plate, that is, it is preferable that the reflection polarizer does not include other cholesteric liquid crystal layers.

Hereinafter, the light reflection layer will be described below.

The first light reflection layer has a reflection center wavelength in a wavelength range of 430 nm to 480 nm and a reflectivity peak having a half-width of less than or equal to 100 nm.

It is preferable that the reflection center wavelength of the first light reflection layer is in a wavelength range of 430 nm to 470 nm.

The half-width of the reflectivity peak of the first light reflection layer is preferably less than or equal to 100 nm, is more preferably less than or equal to 80 nm, and is particularly preferably less than or equal to 70 nm.

The second light reflection layer has a reflection center wavelength in a wavelength range of 500 nm to 600 nm and a reflectivity peak having a half-width of less than or equal to 100 nm.

It is preferable that the reflection center wavelength of the second light reflection layer is in a wavelength range of 520 nm to 560 nm

The half-width of the reflectivity peak of the second light reflection layer is preferably less than or equal to 100 nm, is more preferably less than or equal to 80 nm, and is particularly preferably less than or equal to 70 nm.

The third light reflection layer has a reflection center wavelength in a wavelength range of 600 nm to 650 nm and a reflectivity peak having a half-width of less than or equal to 100 nm.

It is preferable that the reflection center wavelength of the third light reflection layer is in a wavelength range of 610 nm to 640 nm.

The half-width of the reflectivity peak of the third light reflection layer is preferably less than or equal to 100 nm, is more preferably less than or equal to 80 nm, and is particularly preferably less than or equal to 70 nm.

A wavelength providing a peak (that is, a reflection center wavelength) is able to be adjusted by changing the pitch or the refractive index of the cholesteric liquid crystal layer, and changing the pitch easily adjusts the wavelength by changing the added amount of a chiral agent. Specifically, the details are disclosed in Fuji Film Research & Development No. 50 (2005) pp. 60 to 63.

The lamination order of the first light reflection layer, the second light reflection layer, and third light reflection layer will be described. Front brightness is able to be improved in any lamination order. However, coloring occurs due to the influence of the first light reflection layer, the second light reflection layer, and the third light reflection layer in an oblique azimuth. This is due to the following two reasons. One reason is that the reflectivity peak wavelength of the light reflection layer is shifted to a short wave side with respect to the peak wavelength of the front surface in the oblique azimuth. For example, in the light reflection layer having a reflection center wavelength in a wavelength range of 500 nm to 600 nm, the center wavelength is shifted to a wavelength range of 400 nm to 500 nm in the oblique azimuth. The other reason is that the light reflection layer functions as a negative C plate (a positive retardation plate in Rth) in a wavelength range where the light reflection layer does not reflect light, and thus, the coloring occurs due to the influence of retardation in the oblique azimuth. The present inventors have specifically conducted studies with respect to the reasons for the coloring, and thus, have found that there is an arrangement order which is most preferable for suppressing the coloring according to the lamination order of the first light reflection layer, the second light reflection layer, and the third light reflection layer. That is, it is most preferable that the first light reflection layer having the smallest wavelength is positioned on the light source side (a blue layer: B), the third light reflection layer having the largest wavelength is positioned (a red layer: R), and then, the second light reflection layer having the intermediate wavelength (a green layer: G) is positioned as seen from the backlight unit (the light source) side. That is, an order of BRG (the first light reflection layer, the third light reflection layer, and the second light reflection layer) is obtained from the backlight unit (the light source).

The lamination order of the first light reflection layer, the second light reflection layer, and the third light reflection layer is any one of arrangement orders such as an order of BRG (the first light reflection layer, the third light reflection layer, and the second light reflection layer), an order of BGR (the first light reflection layer, the second light reflection layer, and the third light reflection layer), an order of GBR (the second light reflection layer, the first light reflection layer, and the third light reflection layer), an order of GRB (the second light reflection layer, the third light reflection layer, and the first light reflection layer), an order of RBG (the third light reflection layer, the first light reflection layer, and the second light reflection layer), or an order of RGB (the third light reflection layer, the second light reflection layer, and the first light reflection layer) from the backlight unit side;

the arrangement order such as the order of BRG (the first light reflection layer, the third light reflection layer, and the second light reflection layer), the order of BGR (the first light reflection layer, the second light reflection layer, and the third light reflection layer), or the order of GBR (the second light reflection layer, the first light reflection layer, and the third light reflection layer) from the backlight unit side is preferable; and

the arrangement order such as the order of BRG (the first light reflection layer, the third light reflection layer, and the second light reflection layer) from the backlight unit side is more preferable.

A manufacturing method of the light reflection layer formed by immobilizing the cholesteric liquid crystalline phase described above is not particularly limited, and for example, methods disclosed in JP1989-133003A (JP-H01-133003A), JP3416302B, JP3363565B, and JP1996-271731A (JP-H08-271731A) are able to be used, and the contents of the publications are incorporated in the present invention. More specifically, the manufacturing method can be referred to the description disclosed in paragraphs [0011] to [0015] of JP1996-271731A (JP-H08-271731A).

The λ/4 plate is a layer for converting the circularly polarized light which exits from the reflection polarizer to the linearly polarized light. Simultaneously, the retardation (Rth) in the thickness direction is adjusted, and thus, positive retardation in the thickness direction which occurs in a case of being seen from the oblique azimuth is able to be cancelled.

Accordingly, it is preferable that the retardation (Rth) of the λ/4 plate in the thickness direction is a value close to 0, and it is more preferable that the retardation (Rth) of the λ/4 plate in the thickness direction is a negative value. A preferred Rth value is different depending on the order of the light reflection layers. As described above, this is because the light reflection layer functions as a negative C plate, that is, a retardation plate of positive Rth in a wavelength range where the light reflection layer does not reflect light, and thus, the order of the light reflection layers directly affects a wavelength which provides preferred retardation. A preferred range of Rth of the λ/4 plate according to the arrangement order of the first light reflection layer, the second light reflection layer, and the third light reflection layer is as shown in Table 1.

TABLE 1

| | Preferred |
|---|---|
| | Range of Rth |
| Arrangement Order of Light Reflection | of λ/4 Plate |
| Layer from Backlight Unit Side | (nm) |
| BRG (First Light Reflection Layer, | −400~−50 |
| Third Light Reflection Layer, | |
| Second Light Reflection Layer) | |
| BGR (First Light Reflection Layer, | −450~−80 |
| Second Light Reflection Layer, | |
| Third Light Reflection Layer) | |
| GRB (Second Light Reflection Layer, | −650~−230 |
| Third Light Reflection Layer, | |
| First Light Reflection Layer) | |
| GBR (Second Light Reflection Layer, | −450~−310 |
| First Light Reflection Layer, | |
| Third Light Reflection Layer) | |
| RBG (Third Light Reflection Layer, | −360~−250 |
| First Light Reflection Layer, | |
| Second Light Reflection Layer) | |
| RGB (Third Light Reflection Layer, | −520~−280 |
| Second Light Reflection Layer, | |
| First Light Reflection Layer) | |

In the λ/4 plate described above, it is preferable that retardation Re(550) in the in-plane direction at a wavelength of 550 nm satisfies Expression (2) described below.

550/(4−25)<Re(550)<550/(4+25) (2)

It is more preferable that Expression (2) is Expression (2′) described below, and it is even more preferable that Expression (2) is Expression (2″) described below.

550 nm/4−15 nm<Re(550)<550 nm/4+15 nm Expression (2′)

550 nm/4−5 nm<Re(550)<550 nm/4+5 nm Expression (2″)

It is preferable that the λ/4 plate described above further satisfies Expressions (1), (3), and (4) described below.

450 nm/4−25 nm<Re(450)<450 nm/4+25 nm Expression (1)

630 nm/4−25 nm<Re(630)<630 nm/4+25 nm Expression (3)

Re(450)<Re(550)<Re(630) Expression (4)

It is preferable that Expressions (1), (3), and (4) are Expressions (1′), (3′), and (4′) described below.

450 nm/4−15 nm<Re(450)<450 nm/4+15 nm Expression (1′)

630 nm/4−15 nm<Re(630)<630 nm/4+15 nm Expression (3′)

Re(450)<Re(550)<Re(630) Expression (4′)

It is more preferable that Expressions (1), (3), and (4) are Expressions (1″), (3″), and (4″) described below.

450 nm/4−5 nm<Re(450)<450 nm/4+5 nm Expression (1″)

630 nm/4−5 nm<Re(630)<630 nm/4+5 nm Expression (3″)

Re(450)<Re(550)<Re(630) Expression (4″)

A manufacturing method of the λ/4 plate is not particularly limited. Examples of a ¼ wavelength plate formed of a superposed body of the retardation film include a ¼ wavelength plate in which a retardation film providing retardation of a ½ wavelength with respect to monochromatic light and a retardation film providing retardation of a ¼ wavelength with respect to monochromatic light are laminated such that optical axes thereof intersect with each other. By laminating a plurality of retardation films providing retardation of a ½ wavelength or a ¼ wavelength with respect to monochromatic light such that the optical axes intersect with each other, wavelength dispersion of the retardation defined as a product (Δnd) of a refractive index difference (Δn) of birefringent light and a thickness (d) is able to be superposed or modulated, and is able to be arbitrarily controlled, the wavelength dispersion is suppressed while controlling the entire retardation to be in a ¼ wavelength, and thus, it is possible to obtain a wavelength plate providing retardation of a ¼ wavelength over a wide wavelength range. For example, a method disclosed in JP1996-271731A (JP-H08-271731A) is able to be used as the manufacturing method of the λ/4 plate, and the contents of the publication are incorporated in the present invention. More specifically, the manufacturing method can be referred to the description disclosed in paragraphs [0016] to [0024] of JP1996-271731A (JP-H08-271731A).

On the other hand, a λ/4 plate which is prepared as a laminated body of the optical anisotropic layer used as the following λ/2 plate and λ/4 plate is able to be used as the λ/4 plate which preferably satisfies Expression (2), and more preferably satisfies Expressions (1) to (4).

The optical anisotropic layer used as the λ/2 plate and the λ/4 plate is able to be formed of one type or a plurality of types of curable compositions containing a liquid crystal compound as a main component. It is preferable that the liquid crystal compound is a liquid crystal compound having a polymerizable group. A λ/4 plate which is used in the λ/4 plate which preferably satisfies Expression (2), and more preferably satisfies Expressions (1) to (4) may be an optical anisotropic support having a desired λ/4 function in a support itself, or may include an optical anisotropic layer or the like on a support formed of a polymer film. In the latter case, other layers are laminated on the support, and thus, a desired λ/4 function is obtained. The configuration material of the optical anisotropic layer is not particularly limited. The optical anisotropic layer may be a layer which is formed of a composition containing a liquid crystal compound and exhibits optical anisotropy expressed by aligning molecules of the liquid crystal compound or a layer which has optical anisotropy expressed by stretching a polymer film and by aligning the polymer in the film, or may be both of the layers. That is, the optical anisotropic layer is able to be configured of one or two or more biaxial films, and is also able to be configured of a combination of two or more monoaxial films such as a combination of a C plate and an A plate. The optical anisotropic layer is able to be configured of a combination of one or more biaxial films and one or more monoaxial films.

Here, the “λ/4 plate” used in the λ/4 plate which preferably satisfies Expression (2), and more preferably satisfies Expressions (1) to (4) indicates an optical anisotropic layer in which in-plane retardation Re(λ) at a specific wavelength of λ nm satisfies Re(2)=λ/4. The expression described above may be attained at any wavelength (for example, 550 nm) in a visible light region, and in-plane retardation Re(550) at a wavelength of 550 nm is preferably 115 nm≦Re(550)≦155 nm, and is more preferably in a range of 120 nm to 145 nm. It is preferable that the in-plane retardation Re(550) at a wavelength of 550 nm is in this range since light leakage of reflected light is able to be reduced to the extent of being invisible at the time of being combined with the λ/2 plate described below.

A λ/2 plate which is used in the λ/4 plate which preferably satisfies Expression (2), and more preferably satisfies Expressions (1) to (4) may be an optical anisotropic support having a desired λ/2 function in a support itself, or may include an optical anisotropic layer or the like on a support formed of a polymer film. In the latter case, other layers are laminated on the support, and thus, a desired λ/2 function is obtained. The configuration material of the optical anisotropic layer is not particularly limited. The optical anisotropic layer may be a layer which is formed of a composition containing a liquid crystal compound and exhibits optical anisotropy expressed by aligning molecules of the liquid crystal compound or a layer which has optical anisotropy expressed by stretching a polymer film and by aligning the polymer in the film, or may be both of the layers. That is, the optical anisotropic layer is able to be configured of one or two or more biaxial films, and is also able to be configured of a combination of two or more monoaxial films such as a combination of a C plate and an A plate. The optical anisotropic layer is able to be configured of a combination of one or more biaxial films and one or more monoaxial films

Here, the “λ/2 plate” used in the λ/4 plate (C) which preferably satisfies Expression (2), and more preferably satisfies Expressions (1) to (4) indicates an optical anisotropic layer in which in-plane retardation Re(λ) at a specific wavelength of λ nm satisfies Re(λ)=λ/2. The expression described above may be attained at any wavelength (for example, 550 nm) in a visible light region. Further, it is preferable that in-plane retardation Re1 of the λ/2 plate is set to be substantially two times in-plane retardation Re2 of the λ/4 plate.

Here, the “retardation is substantially two times” indicates that Re1=2×Re2±50 nm.

Re1=2×Re2±20 nm is more preferable, and Re1=2×Re2±10 nm is even more preferable. The expression described above may be attained at any one wavelength in a visible light region, and it is preferable that the expression described above is attained at a wavelength of 550 nm. It is preferable that the in-plane retardation Re(550) at a wavelength of 550 nm is in this range since the light leakage of the reflected light is able to be reduced to the extent of being invisible at the time of being combined with the λ/4 plate described below.

In a case where the polarizing plate including the optical conversion member and the reflection polarizer described above is arranged on the backlight side polarizing plate as the brightness enhancement layer, the direction of the linearly polarized light which exits from the reflection polarizer and is transmitted through the λ/4 plate is laminated to be parallel to a transmission axis direction of the backlight side polarizing plate.

In a case where the λ/4 plate is a single layer, an angle between a slow axis direction of the λ/4 plate and an absorption axis direction of the polarizing plate is 45°.

In a case where the λ/4 plate is a laminated body of a λ/4 plate and a λ/2 plate, the angles between the slow axis directions of each of the λ/4 plate and the λ/2 plate and the absorption axis direction of the polarizing plate have the following positional relationship.

In a case where Rth of the λ/2 plate at a wavelength of 550 nm is negative, an angle between the slow axis direction of the λ/2 plate and the absorption axis direction of the polarizer is preferably in a range of 75°±8°, is more preferably in a range of 75°±6°, and is even more preferably in a range of 75°±3°. Further, at this time, the angle between the slow axis direction of the λ/4 plate and the absorption axis direction of the polarizing plate is preferably in a range of 15°±8°, is more preferably in a range of 15°±6°, and is even more preferably in a range of 15°±3°. It is preferable that the angle is in the range described above since the light leakage of the reflected light is able to be reduced to the extent of being invisible.

In addition, in a case where Rth of the λ/2 plate at a wavelength of 550 nm is positive, the angle between the slow axis direction of the λ/2 plate and the absorption axis direction of the polarizing plate is preferably in a range of 15°±8°, is more preferably in a range of 15°±6°, and is even more preferably in a range of 15°±3°. Further, at this time, the angle between the slow axis direction of the λ/4 plate and the absorption axis direction of the polarizing plate is preferably in a range of 75°±8°, is more preferably in a range of 75°±6°, and is even more preferably in a range of 75°±3°. It is preferable that the angle is in the range described above since the light leakage of the reflected light is able to be reduced to the extent of being invisible.

The material of the optical anisotropic support is not particularly limited. A polymer film which is able to be used as the material of the optical anisotropic support, for example, can be referred to the description disclosed in paragraph [0030] of JP2012-108471A.

In a case where the λ/2 plate and the λ/4 plate are a laminated body of the polymer film (a transparent support) and the optical anisotropic layer, it is preferable that the optical anisotropic layer includes at least one layer which is formed of a composition containing a liquid crystal compound. That is, it is preferable that the λ/2 plate and the λ/4 plate are a laminated body of the polymer film (the transparent support) and the optical anisotropic layer formed of the composition containing the liquid crystal compound. A polymer film having small optical anisotropy may be used in the transparent support, or a polymer film exhibiting optical anisotropy by a stretching treatment or the like may be used. It is preferable that the support has light transmittance of greater than or equal to 80%.

The type of the liquid crystal compound to be used for forming the optical anisotropic layer which may be included in the λ/2 plate and the λ/4 plate is not particularly limited. The details thereof, for example, can be referred to the description disclosed in paragraphs [0032] and [0033] of JP2012-108471A.

In general, the liquid crystal compound is able to be classified into a rod-like liquid crystal compound and a disk-like liquid crystal compound according to the shape thereof. Further, each of the rod-like liquid crystal compound and the disk-like liquid crystal compound has a low molecular type and a high molecular type. In general, the polymer indicates that the degree of polymerization is greater than or equal to 100 (Polymer Physics and Phase Transition Dynamics, written by Masao DOI, Page. 2, published by Iwanami Shoten, Publishers., 1992). In the present invention, any liquid crystal compound is able to be used, and it is preferable to use the rod-like liquid crystal compound or the disk-like liquid crystal compound. Two or more types of rod-like liquid crystal compounds, two or more types of disk-like liquid crystal compounds, or a mixture of the rod-like liquid crystal compound and the disk-like liquid crystal compound may be used. It is more preferable that the rod-like liquid crystal compound or the disk-like liquid crystal compound having a reactive group is used for forming the optical anisotropic layer, and it is even more preferable that at least one of the rod-like liquid crystal compound and the disk-like liquid crystal compound has two or more reactive groups in one liquid crystal molecule, from the viewpoint of enabling a change in temperature or humidity to decrease. The liquid crystal compound may be a mixture of two or more types of liquid crystal compounds, and in this case, it is preferable that at least one of the liquid crystal compounds has two or more reactive groups.

For example, a rod-like liquid crystal compound disclosed in JP1999-513019A (JP-H11-513019A) or JP2007-279688A is able to be preferably used as the rod-like liquid crystal compound, and for example, a discotic liquid crystal compound disclosed in JP2007-108732A or JP2010-244038A is able to be preferably used as the discotic liquid crystal compound, but the rod-like liquid crystal compound and the disk-like liquid crystal compound are not particularly limited.

In a case where the λ/2 plate and the λ/4 plate include the optical anisotropic layer containing the liquid crystal compound, the optical anisotropic layer may formed of one layer, or may be a laminated body of two or more optical anisotropic layers.

The formation of the optical anisotropic layer, for example, can be referred to the description disclosed in paragraphs [0035], [0201], [0202] to [0211] of JP2012-108471A.

In-plane retardation (Re) of the transparent support (the polymer film) supporting the optical anisotropic layer is preferably 0 nm to 50 nm, is more preferably 0 nm to 30 nm, and is even more preferably 0 nm to 10 nm. It is preferable that the in-plane retardation (Re) is in the range described above since the light leakage of the reflected light is able to be reduced to the extent of being invisible.

In addition, it is preferable that retardation (Rth) of the support in the thickness direction is selected according to a combination with the optical anisotropic layer which is disposed on or under the support. Accordingly, the light leakage of the reflected light and shading at the time of being observed from the oblique direction are able to be reduced.

Examples of a polymer configuring the support include polymers disclosed in paragraph [0213] of JP2012-108471A. Among them, triacetyl cellulose, diacetyl cellulose, polyethylene terephthalate, and a polymer having an alicyclic structure are preferable, and the triacetyl cellulose is particularly preferable.

The thickness of the transparent support, for example, is approximately 10 μm to 200 μm, and is preferably 10 μm to 80 μm, and it is preferable that the thickness of the transparent support is 20 μm to 60 μm from the viewpoint of suppressing external light reflection. In addition, the transparent support may be formed by laminating a plurality of layers. In order to improve adhesion between the transparent support and the optical anisotropic layer disposed on the transparent support, the transparent support may be subjected to a surface treatment (for example, a glow discharge treatment, a corona discharge treatment, an ultraviolet ray (UV) treatment, and a flame treatment). An adhesive layer (an undercoat layer) may be disposed on the transparent support. In addition, it is preferable that a transparent support in which a polymer layer mixed with inorganic particles having an average particle diameter of approximately 10 nm to 100 nm at a weight ratio of solid contents of 5% to 40% is applied onto one surface of the support or is cocast with the support in order to apply slidability in a transporting step or to prevent a back surface from being bonded to the surface after being wound is used in the transparent support or a long transparent support.

(Liquid Crystal Cell)

The driving mode of the liquid crystal cell is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode are able to be used.

In general, the liquid crystal cell includes two substrates, and a liquid crystal layer positioned between the two substrates. In general, the substrate is a glass substrate, or may be a plastic substrate or a laminated body of a glass substrate and a plastic substrate. In a case where the plastic substrate is independently used as the substrate, a material such as polycarbonate (PC) and polyether sulfone (PES), which rarely has in-plane optical anisotropy, is useful since such a material does not inhibit polarization control of the liquid crystal layer. In general, the thickness of one substrate is in a range of 50 μm to 2 mm.

In general, the liquid crystal layer of the liquid crystal cell is formed by sealing a space which is formed by interposing a spacer between the two substrates with a liquid crystal. In general, a transparent electrode layer is formed on the substrate as a transparent film containing a conductive substance. Further, layers such as a gas barrier layer, a hard coat layer, and an undercoat layer which is used for adhesion of the transparent electrode layer may be disposed on the liquid crystal cell. In general, such layers are disposed on the substrate.

(Polarizer)

A polarizing plate other than the polarizing plate containing the optical conversion member described above is not particularly limited, a polarizing plate which is generally used in a liquid crystal display device is able to be used without any limitation. For example, a polarizing plate including a stretched film or the like which is formed by dipping a polyvinyl alcohol film in an iodine solution, and by stretching the film as a polarizer is able to be used. The thickness of the polarizer is not particularly limited. It is preferable that the thickness of the polarizer is thin from the viewpoint of thinning the liquid crystal display device, and it is preferable that the polarizer has a constant thickness in order to maintain the contrast of the polarizing plate. From the viewpoint described above, the thicknesses of a visible side polarizer and a backlight side polarizer are preferably in a range of 0.5 μm to 80 μm, are more preferably in a range of 0.5 μm to 50 μm, and are even more preferably in a range of 1 μm to 25 μm. In addition, the thicknesses of the visible side polarizer and the backlight side polarizer may be identical to each other or different from each other. The details of the polarizer can be referred to the description disclosed in paragraphs [0037] to [0046] of JP2012-189818A.

(Protective Film)

In general, the polarizing plate includes a protective film on one surface or both surfaces of the polarizer. In the liquid crystal panel according to one embodiment of the present invention, each of the visible side polarizer and the backlight side polarizer may include the protective film on one surface or both surfaces. The thickness of the protective film is able to be suitably set, and in general, the thickness of the protective film is approximately 1 μm to 500 μm, is preferably 1 μm to 300 μm, is more preferably 5 μm to 200 μm, and is even more preferably 5 μm to 150 μm, from the viewpoint of workability such as strength or handling, a reduction in layer thickness, or the like. Furthermore, the visible side polarizer and the backlight side polarizer may be bonded to the liquid crystal cell without using the protective film. This is because, in particular, the substrate of the liquid crystal cell is able to exhibit a barrier function.

A thermoplastic resin having excellent transparency, mechanical strength, thermal stability, moisture blocking properties, and isotropy is preferably used as the protective film of the polarizing plate. Specific examples of such a thermoplastic resin include a cellulose resin such as triacetyl cellulose, a polyester resin, a polyether sulfone resin, a polysulfone resin, a polycarbonate resin, a polyamide resin, a polyimide resin, a polyolefin resin, a (meth)acrylic resin, a cyclic polyolefin resin (a norbornene-based resin), a polyarylate resin, a polystyrene resin, a polyvinyl alcohol resin, and a mixture thereof. The details of the resins which are able to be used as the protective film can be referred to the description disclosed in paragraphs [0049] to [0054] of JP2012-189818A.

A polarizing plate protective film including one or more functional layers on a thermoplastic resin film is able to be used as the polarizing plate protective film. Examples of the functional layer include a layer of low moisture permeability, a hard coat layer, an anti-reflection layer (a layer in which a refractive index is adjusted, such as a layer of low refractive index, a layer of intermediate refractive index, and a layer of high refractive index), an antiglare layer, an antistatic layer, an ultraviolet absorbing layer, and the like. For example, using a protective film including a layer of low moisture permeability as the polarizing plate protective film is effective from the viewpoint of suppressing the deformation of the polarizer due to a humidity change. A known technology is able to be applied to such a functional layer without any limitation. The thickness of the protective film including the functional layer, for example, is in a range of 5 μm to 100 μm, is preferably in a range of 10 μm to 80 μm, and is more preferably in a range of 15 μm to 75 μm. Furthermore, only the functional layer is able to be laminated on the polarizer without using the thermoplastic resin film.

(Adhesive Layer and Pressure Sensitive Adhesive Layer)

The polarizer and the protective film are able to be bonded to each other by a known adhesive layer or a known pressure sensitive adhesive layer. The details, for example, can be referred to the description disclosed in paragraphs [0056] to [0058] of JP2012-189818A and paragraphs [0061] to [0063] of JP2012-133296A. In addition, in the liquid crystal panel, the liquid crystal display device, the polarizing plate, and the polarizing plate protective film according to one embodiment of the present invention, in a case where the layers and the members are bonded to each other, the known adhesive agent or the known pressure sensitive adhesive layer is able to be used. Even in a case where the polarizing plate including the optical conversion member described above is bonded to the other member (for example, the liquid crystal cell or the backlight side polarizing plate), the known adhesive layer or the known pressure sensitive adhesive layer is able to be used. Alternatively, the layers and the members are able to be bonded to each other by lamination using an adhesive agent or lamination without using an adhesive agent (thermal pressure bonding).

(Retardation Layer)

The visible side polarizing plate and the backlight side polarizing plate are able to include at least one retardation layer between the liquid crystal cell, and the visible side polarizing plate and the backlight side polarizing plate. For example, the retardation layer may be included as an inner side polarizing plate protective film on the liquid crystal cell side. A known cellulose acylate film or the like is able to be used as such a retardation layer.

Furthermore, the liquid crystal panel of a second liquid crystal display device described below can be referred to description described above except that the optical conversion member according to one embodiment of present invention is arranged on the backlight unit.

[First Liquid Crystal Display Device]

Another embodiment of the present invention relates to a liquid crystal display device (a first liquid crystal display device) including the liquid crystal panel described above and a backlight unit including a light source. The configuration of the backlight unit can be referred to the following description. In addition, the configuration of the liquid crystal display device will be described below.

In the above description, an embodiment in which the optical conversion member according to one embodiment of the present invention is included in the liquid crystal panel has been described, but the optical conversion member according to one embodiment of the present invention is able to be used as a configuration member of the backlight unit. The details thereof will be described below.

[Backlight Unit]

Another embodiment of the present invention relates to a backlight unit including the optical conversion member described above and a light source.

The configuration of the backlight unit may be an edge light mode backlight unit including a light guide plate, a reflection plate, and the like as a configuration member, or may be a direct backlight mode backlight unit. In the edge light mode backlight unit, in one embodiment, the optical conversion member is arranged on a path of light which exits from the light guide plate. In another embodiment, the optical conversion member is arranged between the light guide plate and the light source. A known light guide plate is able to be used as the light guide plate without any limitation.

In one embodiment, a light source which emits blue light having a light emission center wavelength in a wavelength range of 430 nm to 480 nm, for example, a blue light emitting diode which emits blue light is able to be used as the light source. In a case where the light source emitting the blue light is used, it is preferable that at least a quantum dot (A) emitting red light which is excited by excitation light and a quantum dot (B) emitting green light are contained in the optical conversion layer. Accordingly, it is possible to embody the white light by blue light which is emitted from the light source and is transmitted through the optical conversion member, and red light and green light which are emitted from the optical conversion member. Alternatively, in another embodiment, a light source which emits ultraviolet light having a light emission center wavelength in a wavelength range of 300 nm to 430 nm, for example, an ultraviolet light emitting diode is able to be used as the light source. In this case, it is preferable that a quantum dot (C) emitting blue light which is excited by excitation light is contained in the optical conversion layer along with the quantum dots (A) and (B). Accordingly, it is possible to embody the white light by the red light, the green light, and the blue light which are emitted from the optical conversion member.

In addition, the backlight unit is able to include a reflection member in the rear portion of the light source. Such a reflection member is not particularly limited, but known reflection members disclosed in JP3416302B, JP3363565B, JP4091978B, JP3448626B, and the like are able to be used, and the contents of the publications are incorporated in the present invention.

It is also preferable that the backlight unit includes a wavelength selective filter for a blue color which selectively transmits light having a wavelength shorter than 460 nm in blue light.

In addition, it is also preferable that the backlight unit includes a wavelength selective filter for a red color which selectively transmits light having a wavelength longer than 630 nm in red light.

Such a wavelength selective filter for a blue color or a wavelength selective filter for a red color is not particularly limited, and a known wavelength selective filter is also able to be used. Such a filter is disclosed in JP2008-52067A or the like, and the contents of the publication are incorporated in the present invention.

In addition, it is also preferable that the backlight unit includes a known diffusion plate or diffusion sheet, a known prism sheet (for example, BEF series or the like manufactured by Sumitomo 3M Ltd.), a brightness enhancement film (for example, DBEF series manufactured by Sumitomo 3M Ltd.), and a known light guide device. The other members are disclosed in JP3416302B, JP3363565B, JP4091978B, JP3448626B, and the like, and the contents of the publications are incorporated in the present invention.

In one embodiment, the backlight unit described above includes the polarizing plate according to one embodiment of the present invention described above, that is, a polarizing plate including the optical conversion member described above, the polarizer which is the cholesteric liquid crystal layer allowing the circularly polarized light to exit, and the λ/4 plate between the optical conversion member and the cholesteric liquid crystal layer as the adjacent layer which is directly in contact with the polyvinyl acetal resin layer of the optical conversion member. It is preferable that the polarizer of the polarizing plate described above is a reflection polarizer. The details thereof are as described above. Such a polarizing plate has both of an optical conversion function and a brightness improvement function. It is preferable that the optical conversion member and the reflection polarizer are incorporated in the backlight unit such that the optical conversion member is positioned on the liquid crystal panel side and the reflection polarizer is positioned on the light source side. Accordingly, the circularly polarized light which exits from the reflection polarizer is able to be converted into the linearly polarized light by the λ/4 plate, and is able to be subjected to optical conversion (wavelength conversion) in the optical conversion member, and then, is able to be incident on the liquid crystal panel.

Furthermore, the backlight unit of the first liquid crystal display device can be referred to the above description of the backlight unit according to one embodiment of the present invention except that the optical conversion member is arranged on the liquid crystal panel.

[Second Liquid Crystal Display Device]

Another embodiment of the present invention relates to a liquid crystal display device (a second liquid crystal display device) including a liquid crystal panel, and the backlight unit according to one embodiment of the present invention.

Hereinafter, common points in both of the first liquid crystal display device and the second liquid crystal display device will be described.

(Light Emission Wavelength)

It is preferable that a backlight unit which is a multi-wavelength light source is used as the backlight unit from the viewpoint of realizing a high brightness and a high color reproducibility. Preferred embodiments are able to include a backlight unit which emits blue light having a light emission center wavelength in a wavelength range of 430 nm to 480 nm and a light emission intensity peak having a half-width of less than or equal to 100 nm, green light having a light emission center wavelength in a wavelength range of 500 nm to 600 nm and a light emission intensity peak having a half-width of less than or equal to 100 nm, and red light having a light emission center wavelength in a wavelength range of 600 nm to 680 nm and a light emission intensity peak having a half-width of less than or equal to 100 nm.

The wavelength range of the blue light is preferably 450 nm to 480 nm, and is more preferably 460 nm to 470 nm, from the viewpoint of further improving brightness and color reproducibility.

The wavelength range of the green light is preferably 520 nm to 550 nm, and is more preferably 530 nm to 540 nm, from the same viewpoint.

In addition, the wavelength range of the red light is preferably 610 nm to 650 nm, and is more preferably 620 nm to 640 nm, from the same viewpoint.

All of the half-widths of the respective light emission intensities of the blue light, the green light, and the red light are preferably less than or equal to 80 nm, are more preferably less than or equal to 50 nm, are even more preferably less than or equal to 45 nm, are still more preferably less than or equal to 40 nm, from the same viewpoint. Among them, it is particularly preferable that the half-width of each of the light emission intensity of the blue light is less than or equal to 30 nm.

In one embodiment of the liquid crystal display device, the liquid crystal display device includes a liquid crystal cell in which a liquid crystal layer is interposed between facing substrates of which at least one includes an electrode, and the liquid crystal cell is configured by being arranged between two polarizing plates. The liquid crystal display device includes the liquid crystal cell in which a liquid crystal is sealed between upper and lower substrates, changes the alignment state of the liquid crystal by applying a voltage, and thus, displays an image. Further, as necessary, the liquid crystal display device includes an associated functional layer such as a polarizing plate protective film or an optical compensation member performing optical compensation, and an adhesive layer. In addition, a surface layer such as a forward scattering layer, a primer layer, an antistatic layer, and an undercoat layer may be arranged along with (or instead of) a color filter substrate, a thin layer transistor substrate, a lens film, a diffusion sheet, a hard coat layer, an anti-reflection layer, a low reflection layer, an antiglare layer, and the like.

The liquid crystal display device according to one embodiment of the present invention as described above includes the optical conversion member which is able to have excellent weather fastness and high transparency, and thus, it is possible to realize a high brightness and a high color reproducibility for a long period of time.

### EXAMPLES

Hereinafter, the characteristics of the present invention will be more specifically described with reference to examples. Materials, used amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

The evaluation of polyvinyl alcohol (PVA) used in the following examples and comparative examples and prepared polyvinyl butyral (PVB) was performed by the following method.

(Average Degree of Polymerization of PVA)

Measurement was performed on the basis of JIS K6726: 1994. As described above, the average degree of polymerization of polyvinyl acetal is coincident with the average degree of polymerization of polyvinyl alcohol which becomes a raw material.

(Amount of Vinyl Acetate Component of PVB)

Measurement was performed on the basis of JIS K6728: 1977.

(Amount of Vinyl Alcohol Component of PVB)

Measurement was performed on the basis of JIS K6728: 1977.

(Acid Value of PVB)

Measurement was performed on the basis of JIS K6728: 1977.

1. Manufacturing Example of Polyvinyl Butyral

### Manufacturing Example 1

1700 kg of an aqueous solution of PVA of 7.5 mass % (an average degree of polymerization of 1000 and a degree of saponification of 99 mol %), 74.6 kg of butyl aldehyde, and 0.13 kg of 2,6-di-t-butyl-4-methyl phenol were put into a reactor of 2 m³ provided with a stirrer, and the entire composition was cooled to 14° C.

Here, 160.1 L of an aqueous solution of a nitric acid having a concentration of 20 mass % was added, and butyralization of PVA was initiated. Heating was initiated after 10 minutes from the addition and was performed for 90 minutes until the temperature became 65° C., and, a reaction was performed for 120 minutes. After that, cooling was performed until the temperature became room temperature, and educed PVB was filtered and was washed with 10 times the amount of ion exchange water to PVB 10 times. After that, neutralization was sufficiently performed by using an aqueous solution of sodium hydroxide of 0.3 mass %, washing was performed by using 10 times the amount of ion exchange water to PVB 10 times, and dehydration was performed, and then, drying was performed, and thus, PVB (PVB-1) was obtained. The analysis results of the obtained PVB are shown in Table 2.

### Manufacturing Examples 2 to 7

PVB (PVB-2 to PVB-7) was obtained by the same method as that in Manufacturing Example 1 except that PVA (a degree of saponification of 99 mol %) having the same average degree of polymerization as the average degree of polymerization of PVB shown in Table 1 was used instead of PVA of Manufacturing Example 1. The analysis results of the obtained PVB are shown in Table 2.

TABLE 2

| | | Amount | Amount | |
|---|---|---|---|---|
| | | of Vinyl | of Vinyl | Acid |
| | Average | Acetate | Alcohol | Value |
| | Degree of | Component | Component | of PVB |
| | Polymerization | (mol %) | (mol %) | (KOHmg/g) |
| PVB-1 | 1000 | 1 | 28.5 | 0.1 |
| PVB-2 | 500 | 1 | 28.5 | 0.1 |
| PVB-3 | 600 | 1 | 28.5 | 0.1 |
| PVB-4 | 700 | 1 | 28.5 | 0.1 |
| PVB-5 | 1100 | 1 | 28.5 | 0.1 |
| PVB-6 | 1200 | 1 | 28.5 | 0.1 |
| PVB-7 | 1700 | 1 | 28.5 | 0.1 |

2. Manufacturing Example of Optical Conversion Member and Liquid Crystal Display Device (Examples and Comparative Examples)

### Example 1

### 1. Preparation of Optical Conversion Layer (Organic Layer Containing Quantum Dot) 1

A quantum dot dispersion 1 described below was prepared, was filtered through a polypropylene filter having a hole diameter of 0.2 μm, and then, was subjected to reduced pressure drying for 30 minutes, and thus, was used as a coating liquid. The coating liquid was applied onto a glass substrate, and then, was immobilized by being irradiated with an ultraviolet ray using an air-cooled metal halide lamp (manufactured by EYE GRAPHICS CO., LTD.) of 160 W/cm² under nitrogen, and then, was peeled off from the glass substrate. An optical conversion layer 1 containing the quantum dot was prepared. The film thickness of the optical conversion layer 1 was 280 μm.

Composition for Optical Conversion Layer 1
(Quantum Dot Dispersion 1)
Containing Quantum Dot

| | | |
|---|---|---|
| Toluene Dispersion of Quantum Dot 1 | 10 | parts by mass |
| (Maximum Light Emission: 520 nm) | | |
| Toluene Dispersion of Quantum Dot 2 | 1 | part by mass |
| (Maximum Light Emission: 630 nm) | | |
| Lauryl Methacrylate | 2.4 | parts by mass |
| Trimethylol Propane Triacrylate | 0.54 | parts by mass |
| Photopolymerization Initiator | 0.009 | parts by mass |

(IRGACURE 819
(manufactured by BASF SE)

A nanocrystal having a core-shell structure (InP/ZnS) described below was used as the quantum dots 1 and 2.

Quantum Dot 1: InP530-10 (Manufactured by NN-LABS, LLC.)

Quantum Dot 2: InP620-10 (Manufactured by NN-LABS, LLC.)

2. Preparation of PVB Sheet

25 ppm of an acetic acid and 175 ppm of magnesium acetate (the amount is based on the mass of PVB) were added to PVB (PVB-1) synthesized in Manufacturing Example 1 as a buffer agent for adjusting pH, pressing was performed at a pressure of 100 Kgf/cm² and a heating plate temperature of 150° C. for 10 minutes, and thus, a PVB sheet 1 having a thickness of 0.76 mm was prepared.

3. Preparation of PVB Sealed Optical Conversion Member

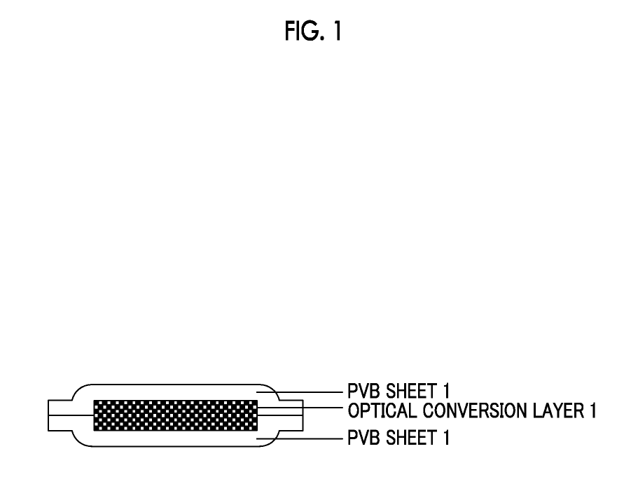

The PVB sheet 1 having a size of 100 mm×100 mm, the optical conversion layer 1 having a size of 90 mm×90 mm, the PVB sheet 1 having a size of 100 mm×100 mm were sequentially superposed on a heating plate of a vacuum laminator (1522N, manufactured by Nisshinbo Mechatronics Inc.), and were laminated without using an adhesive agent (thermal pressure bonding) in the following conditions, and thus, a PVB sealed optical conversion member 1 having a configuration illustrated in FIG. 1 was prepared.

<Conditions>

Heating Plate Temperature: 165° C.

Vacuum Evacuation Time: 12 minutes

Pressing Pressure: 50 kPa

Pressing Time: 17 minutes

### Examples 2 to 9

PVB sealed optical conversion members 2 to 9 were prepared by the same method as that in Example 1 except that PVB used for preparing the PVB sheet was changed to PVB (PVB 2 to PVB 9) synthesized in Manufacturing Examples 2 to 9, and a plasticizer having an amount shown in Table 3 was added to 100 parts by mass of PVB in Examples 2 and 3.

In Examples 2 and 3, triethylene glycol-di(2-ethyl hexanoate) (an acid value of 0.02 KOHmg/g) was used as the plasticizer.

### Example 10

In the preparation of the optical conversion layer, PVB sealed optical conversion member 10 was prepared by the same method as that in Example 1 except that the dispersion of the quantum dot 1 was changed to a dispersion prepared such that nanocrystal particles having a core-shell structure (InP/ZnS) which were synthesized by a method 2 disclosed in paragraphs [0069] to [0073] of JP2012-509604A to have a maximum light emission of 520 nm became a solution of 1 mass % in toluene by using a quantum dot covered with a resin according to a method disclosed in Example 2 of JP2012-509604A, and the dispersion of the quantum dot 2 was changed to a dispersion prepared such that nanocrystal particles having a core-shell structure (InP/ZnS) which were synthesized by the method 2 described above to have a maximum light emission of 630 nm became a solution of 1 mass % in toluene by using a quantum dot covered with a resin according to a method disclosed in Example 2 of JP2012-509604A.

### Example 11

In the preparation of the optical conversion layer, a PVB sealed optical conversion member 11 was prepared by the same method as that in Example 10 except that 0.002 parts by mass of boric acrylate described below was added to the coating liquid of the optical conversion layer 10.

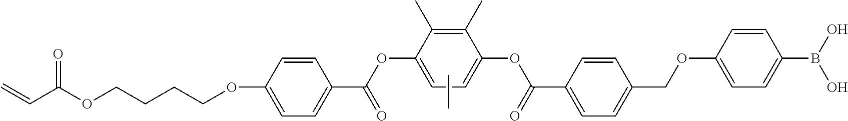

### Comparative Example 1

### Synthesis of CdSe Nanocrystal

CdSe nanocrystal particles which were synthesized to have a maximum light emission of 520 nm by a method disclosed in JP2006-521278A were prepared, and toluene was added such that a solution of 1 mass % was obtained, and thus, a CdSe nanocrystal dispersion 1 was prepared. In addition, a CdSe nanocrystal was prepared by a method disclosed in JP2006-521278A to have a maximum light emission of 630 nm, and toluene was added such that a solution of 1 mass % was obtained, and thus, a CdSe nanocrystal dispersion 2 was prepared.

(Preparation of Quantum Dot Dispersion A)

As described below, a dispersion A containing a quantum dot was prepared.

Composition for Optical Conversion Layer
(Quantum Dot Dispersion A)
Containing Quantum Dot

| | |
|---|---|
| Resin: PVB-1 | 3 parts by mass |
| Solvent: Diethyl Ketone | 7 parts by mass |
| Quantum Dot 1: CdSe Nanocrystal | 10 parts by mass |
| Dispersion 1 | |
| Quantum Dot 2: CdSe Nanocrystal | 1 part by mass |
| Dispersion 2 | |

The quantum dot dispersion A was supplied to a ball mill, 25 ppm of an acetic acid and 175 ppm of magnesium acetate (the amount is based on the mass of PVB) were added as a buffer agent for adjusting pH, and were stirred and mixed for 24 hours, and thus, a coating solution was obtained.

(Preparation of Optical Conversion Layer)

The coating solution was applied onto a glass substrate such that the thickness of the coating solution after being dried became 280 μm and was dried, and thus, a film was formed. The obtained film was peeled off from the glass, and thus, an optical conversion member (an optical conversion layer) A containing polyvinyl butyral as an organic matrix was obtained.

(Evaluation of Optical Conversion Member)

<Measurement of Haze>

The haze of the optical conversion members prepared in the examples and the comparative examples was measured on the basis of JIS K-7136. From the measurement results, the haze was evaluated on the basis of the following criteria. It is indicated that the haze decreases and the transparency increases as the measured value decreases.

A: Less than or equal to 10%

B: Greater than 10% and less than or equal to 15%

C: Greater than 15%

<Evaluation of Weather Fastness>

The weather fastness of the optical conversion members prepared in the examples and the comparative examples was measured. In the weather fastness, a blue LED of 22 mW and 465 nm was used, a current of 20 mA was applied to this LED package, and the optical conversion member was continuously irradiated with light of the blue LED for 200 hours under the atmosphere, and thus, light emission efficiency of a laminated body after light irradiation was measured. From the measurement results, the weather fastness was evaluated on the basis of the following criteria.

A: The light emission efficiency is greater than or equal to 80% compared to the light emission efficiency before light irradiation.

B: The light emission efficiency is greater than or equal to 60% and less than 80% compared to the light emission efficiency before light irradiation.

C: The light emission efficiency is greater than or equal to 40% and less than 60% compared to the light emission efficiency before light irradiation.

D: The light emission efficiency is less than 40% compared to the light emission efficiency before light irradiation.

The results described above are shown in Table 3.

TABLE 3

| | | | PVB Sheet | | | |
|---|---|---|---|---|---|---|
| | | | | Plasticizer | | |
| | | | | Content | Evaluation | |
| | | | Resin | Parts | | Light |
| | Optical Conversion Member | Quantum Dot Material | PVB Type | by Mass | Haze | Fastness |
| Example 1 | PVB Sealed Optical Conversion Member 1 | Cd-Free Core-Shell Type Quantum Dot Material | PVB-1 | 0 | B | B |
| Example 2 | PVB Sealed Optical Conversion Member 2 | Cd-Free Core-Shell Type Quantum Dot Material | PVB-1 | 4 | B | C |
| Example 3 | PVB Sealed Optical Conversion Member 3 | Cd-Free Core-Shell Type Quantum Dot Material | PVB-1 | 10 | B | C |
| Example 4 | PVB Sealed Optical Conversion Member 4 | Cd-Free Core-Shell Type Quantum Dot Material | PVB-2 | 0 | B | B |
| Example 5 | PVB Sealed Optical Conversion Member 5 | Cd-Free Core-Shell Type Quantum Dot Material | PVB-3 | 0 | B | B |
| Example 6 | PVB Sealed Optical Conversion Member 6 | Cd-Free Core-Shell Type Quantum Dot Material | PVB-4 | 0 | B | B |
| Example 7 | PVB Sealed Optical Conversion Member 7 | Cd-Free Core-Shell Type Quantum Dot Material | PVB-5 | 0 | B | B |
| Example 8 | PVB Sealed Optical Conversion Member 8 | Cd-Free Core-Shell Type Quantum Dot Material | PVB-6 | 0 | B | B |
| Example 9 | PVB Sealed Optical Conversion Member 9 | Cd-Free Core-Shell Type Quantum Dot Material | PVB-7 | 0 | B | B |
| Example 10 | PVB Sealed Optical Conversion Member 10 | Resin Covered Cd Free Core-Shell Type Quantum | PVB-1 | 0 | A | B |
| | | Dot Material | | | | |
| Example 11 | PVB Sealed Optical Conversion Member 11 | Resin Covered Cd Free Core-Shell Type Quantum | PVB-1 | 0 | A | A |
| | (Prepared by Boric Acrylate-Containing | Dot Material | | | | |
| | Coating Liquid) | | | | | |
| Comparative | Optical Conversion Member A | Cd-Containing Quantum Dot Material | PVB-1 | 0 | C | D |
| Example 1 | | | | | | |

From the comparison of the examples with the comparative examples shown in Table 3, it is possible to confirm that the optical conversion member is sealed with the PVB sheet, and thus, the weather fastness of the optical conversion member is able to be improved while maintaining the transparency (low haze).

(Preparation of Liquid Crystal Display Device)

A commercially available liquid crystal display device (Product Name: THL42D2, manufactured by Panasonic Corporation) was disassembled, the optical conversion member prepared in the example was disposed on a light guide plate on which a liquid crystal cell was disposed, and a backlight unit was changed to a B narrowband backlight unit described below, and thus, a liquid crystal display device was manufactured. The used B narrowband backlight unit includes a blue light emitting diode (B-LED manufactured by NICHIA CORPORATION: Blue, a main wavelength of 465 nm, and a half-width of 20 nm) as a light source.

### Example 12

### Formation of λ/4 Plate onto PVB Sheet

A λ/4 plate was prepared as disclosed in paragraphs [0020] to [0033] of JP2003-262727A. Two layers of a liquid crystalline material were applied onto the optical conversion member 10, and the liquid crystalline material was polymerized, and thus, a broadband λ/4 plate was formed.

In the obtained λ/4 plate, Re(450) was 110 nm, Re(550) was 135 nm, Re(630) was 140 nm, and the film thickness was 1.6 μm. The PVB sheet used as the sealing material of the optical conversion member functioned as an alignment film, and thus, the λ/4 plate was able to be prepared without separately disposing an alignment film.

<Formation of Reflection Polarizer>

A first light reflection layer formed by immobilizing a cholesteric liquid crystalline phase, a second light reflection layer formed by immobilizing a cholesteric liquid crystalline phase, and a third light reflection layer formed by immobilizing a cholesteric liquid crystalline phase were formed on the obtained λ/4 plate by coating by changing the added amount of the used chiral agent with reference to Fuji Film Research & Development No. 50 (2005) pp. 60 to 63.

In the obtained first light reflection layer, the reflection center wavelength of the maximum reflectivity peak was 450 nm, the half-width was 40 nm, and the film thickness was 1.8 μm.

In the obtained second light reflection layer, the reflection center wavelength of the maximum reflectivity peak was 550 nm, the half-width was 50 nm, and the film thickness was 2.0 μm.

In the obtained third light reflection layer, the reflection center wavelength of the maximum reflectivity peak was 630 nm, the half-width was 60 nm, and the film thickness was 2.1 μm.

Furthermore, the average refractive index of the first light reflection layer, the second light reflection layer, and the third light reflection layer was 1.57.

In addition, the total thickness of the obtained λ/4 plate and the obtained reflection polarizer was 7.5 μm.

Thus, an optical sheet member 1 was obtained in which the λ/4 plate and the reflection polarizer were laminated on the PVB sealed optical conversion member.

<Manufacturing of Liquid Crystal Display Device>

A commercially available liquid crystal display device (Product Name: TH-L42D2, manufactured by Panasonic Corporation) was disassembled, and a liquid crystal display device of Example 11 was manufactured by using the optical sheet member 1 as a backlight side polarizing plate.

The used RGB narrowband backlight unit includes a blue light emitting diode (B-LED manufactured by NICHIA CORPORATION, a main wavelength of 465 nm, and a half-width of 20 nm) as a light source.

### Comparative Example 2

### Preparation of Polarizing Plate

A commercially available cellulose acylate-based film “TD80UL” (manufactured by Fujifilm Corporation) was used as a front side polarizing plate protective film of the backlight side polarizing plate, and thus, a retardation film was prepared. A commercially available cellulose acylate-based film “TD80UL” (manufactured by Fujifilm Corporation) was used as a rear side polarizing plate protective film of the backlight side polarizing plate. A polarizer was manufactured as disclosed in paragraph [0219] of JP2006-293275A, the retardation film and the polarizing plate protective film described above were respectively bonded to both surfaces of the polarizer, and thus, a polarizing plate was manufactured.

<Manufacturing of Liquid Crystal Display Device>

A commercially available liquid crystal display device (manufactured by Panasonic Corporation, Product Name: TH-L42D2) was disassembled, the polarizing plate prepared by the method described above was used as a backlight side polarizing plate, a brightness enhancement layer (manufactured by 3M Company, Product Name: DBEF) was arranged between the backlight side polarizing plate and the backlight unit without using an adhesive agent in a state where the brightness enhancement layer was able to be separated, and thus, a liquid crystal display device of Comparative Example 2 was prepared. The brightness enhancement layer exhibits reflectivity having a flat peak with respect to an approximately constant wavelength in a region of blue to green to red of 450 nm to 550 nm to 630 nm. In the backlight light source of the liquid crystal display device, the light emission peak wavelength of blue light was 450 nm. In a region of green to red, there was one light emission peak, the peak wavelength was 550 nm, and the half-width was 100 nm.

<Evaluation of Front Brightness>

The front brightness of the liquid crystal display devices prepared in Example 12 and Comparative Example 2 was measured by a method disclosed in JP2009-93166A. From the measurement results, evaluation was performed on the basis of the following criteria. The results are shown in Table 4.

5: More excellent than the front brightness of the liquid crystal display device of Comparative Example 2 by greater than or equal to 30%

4: More excellent than the front brightness of the liquid crystal display device of Comparative Example 2 by greater than or equal to 20% and less than 30%

3: More excellent than the front brightness of the liquid crystal display device of Comparative Example 2 by greater than or equal to 10% and less than 20%

2: Less than or equal to the front brightness of the liquid crystal display device of Comparative Example 2

TABLE 4

| | Evaluation Result |
|---|---|
| | of Front Brightness |
| Example 12 | 4 |
| Comparative Example 2 | 2 |

From the results shown in Table 4, it is possible to confirm that the laminated cholesteric liquid crystal layer functions as a reflection polarizer in Example 12, and thus, the front brightness is able to be considerably improved compared to Comparative Example 2 using a commercially available brightness enhancement layer.

### INDUSTRIAL APPLICABILITY

The present invention is useful in a manufacturing field of a liquid crystal display device.

What is claimed is:

1. An optical conversion member, comprising:
an optical conversion layer containing a quantum dot emitting fluorescent light which is excited by incident excitation light; and
a polyvinyl acetal resin layer.

2. The optical conversion member according to claim 1,
wherein the optical conversion layer includes the polyvinyl acetal resin layer respectively on both main surfaces.

3. The optical conversion member according to claim 1,
wherein the optical conversion layer is sealed with the polyvinyl acetal resin layer.

4. The optical conversion member according to claim 1,
wherein the polyvinyl acetal resin layer is disposed as an adjacent layer which is directly in contact with the optical conversion layer.

5. The optical conversion member according to claim 1,
wherein, in the polyvinyl acetal resin layer, a content of a plasticizer with respect to 100 parts by mass of polyvinyl acetal is less than or equal to 10 parts by mass.

6. The optical conversion member according to claim 5,
wherein the content of the plasticizer with respect to 100 parts by mass of the polyvinyl acetal is greater than or equal to 0 parts by mass and less than 4 parts by mass.

7. The optical conversion member according to claim 1,
wherein an average degree of polymerization of the polyvinyl acetal contained in the polyvinyl acetal resin layer is greater than or equal to 100 and less than or equal to 4000.

8. The optical conversion member according to claim 1,
wherein the optical conversion layer is a cured material layer of a curable composition containing a quantum dot.

9. The optical conversion member according to claim 8,
wherein the curable composition contains a (meth)acrylate compound selected from the group consisting of a monofunctional (meth)acrylate monomer and a multifunctional (meth)acrylate monomer.

10. The optical conversion member according to claim 8,
wherein the curable composition contains a boric acid-based compound selected from the group consisting of a boric acid-containing compound and a boric acid ester-containing compound.

11. The optical conversion member according to claim 1,
wherein the quantum dot includes a semiconductor crystal having a core-shell structure.

12. The optical conversion member according to claim 1,
wherein the quantum dot is a cadmium-free material.

13. The optical conversion member according to claim 1,
wherein the quantum dot is at least one selected from the group consisting of a quantum dot A having a light emission center wavelength in a wavelength range of 600 nm to 680 nm, a quantum dot B having a light emission center wavelength in a wavelength range of 500 nm to 600 nm, and a quantum dot C having a light emission center wavelength in a wavelength range of 400 nm to 500 nm.

14. A polarizing plate, comprising:
the optical conversion member according to claim 1; and
a polarizer which is a cholesteric liquid crystal layer allowing circularly polarized light to exit,
wherein a λ/4 plate is disposed between the optical conversion member and the cholesteric liquid crystal layer as an adjacent layer which is directly in contact with a polyvinyl acetal resin layer of the optical conversion member.

15. The polarizing plate according to claim 14,
wherein the polarizer is a reflection polarizer.

16. A liquid crystal panel, comprising at least:
a liquid crystal cell; and
the polarizing plate according to claim 14.

17. The liquid crystal panel according to claim 16,
wherein the liquid crystal panel includes a visible side polarizing plate, the liquid crystal cell, and a backlight side polarizing plate,
the backlight side polarizing plate is the polarizing plate according to claim 14 or 15, and
the optical conversion member is arranged between the λ/4 plate and the liquid crystal cell.

18. A liquid crystal display device, comprising:
the liquid crystal panel according to claim 16; and
a backlight unit including a light source.

19. A backlight unit, comprising:
the optical conversion member according to claim 1; and
a light source.

20. A liquid crystal display device, comprising:
a liquid crystal panel; and
the backlight unit according to claim 19.
